(19) United States
(12) Patent Application Publication
(10) Pub. No.: US 2019/0091567 A1
(43) Pub. Date: Mar. 28, 2019

(54) GENERATION OF GAMING INSTANCES

(71) Applicant: Zynga Inc., San Francisco, CA (US)

(72) Inventors: James Edgar Huffman, Cedar Park, TX (US); Jared William Twing, Leander, TX (US); Steven Michael Behnke, Leander, TX (US); Harold Allen Hanlin, Round Rock, TX (US)

(21) Appl. No.: 15/714,342

(22) Filed: Sep. 25, 2017

(51) Int. Cl. A63F 13/30; A63F 13/73; A63F 13/45; A63F 13/95; A63F 13/795

(52) U.S. Cl. CPC A63F 13/30; A63F 13/73; A63F 13/795; A63F 13/95; A63F 13/45

(57) ABSTRACT

A system, a machine-readable storage medium storing instructions, and a computer-implemented method are described herein for a challenge engine. The challenge engine identifies a set of player metrics for players within a game and determines properties of at least one metric of the set of player metrics for a specified player. The challenge engine generates a first gaming instance based on the properties of the at least one metric. The first gaming instance is customized to the specified player. The challenge engine detects one or more interactions of the specified player with at least one element of the first gaming instance. In response to the one or more interactions, the challenge engine generates a second gaming instance based on the properties of the at least one metric. The second gaming instance is customized to the specified player and distinct from the first gaming instance.

### TECHNICAL FIELD

The subject matter disclosed herein generally relates to the technical field of special-purpose machines for provision and/or management of virtual objects and gaming instances in a computer-implemented gaming environment, including software-configured computerized variants of such special-purpose machines and improvements to such variants, and to the technologies by which such special-purpose machines become improved compared to other special-purpose machines.

### BACKGROUND

In many games, there is a virtual world or some other imagined playing space where a player/user of the game controls one or more player characters (herein “character,” “player character,” or “PC”). Player characters can be considered in-game representations of the controlling player. As used herein, the terms “player,” “user,” “entity,” and “friend” may refer to the in-game player character controlled by that player, user, entity, or friend, unless context suggests otherwise. The game display can display a representation of the player character. A game engine accepts inputs from the player, determines player character actions, decides outcomes of events and presents the player with a game display illuminating what happened. In some games, there are multiple players, wherein each player controls one or more player characters.

In many computer games, there are various types of in-game assets (aka “rewards” or “loot”) that a player character can obtain within the game. For example, a player character may acquire game points, gold coins, experience points, character levels, character attributes, virtual cash, game keys, or other in-game items of value. In many computer games, there are also various types of in-game obstacles that a player must overcome to advance within the game. In-game obstacles can include tasks, puzzles, opponents, levels, gates, actions, etc. In some games, a goal of the game may be to acquire certain in-game assets, which can then be used to complete in-game tasks or to overcome certain in-game obstacles. For example, a player may be able to acquire a virtual key (i.e., the in-game asset) that can then be used to open a virtual door (i.e., the in-game obstacle).

An electronic social networking system typically operates with one or more social networking servers providing interaction between users such that a user can specify other users of the social networking system as “friends.” A collection of users and the “friend” connections between users can form a social graph that can be traversed to find second, third and more remote connections between users, much like a graph of nodes connected by edges can be traversed.

Many online computer games are operated on an online social networking system. Such an online social networking system allows both users and other parties to interact with the computer games directly, whether to play the games or to retrieve game- or user-related information. Internet users may maintain one or more accounts with various service providers, including, for example, online game networking systems and online social networking systems. Online systems can typically be accessed using browser clients (e.g., Firefox, Chrome, Internet Explorer).

Many games provide gaming instances or gaming environments to users or players of the game which are predefined. Each user interacting with the game will be provided with the same gaming instances or gaming environments. Game developers may randomize or otherwise change an order of the provided gaming instances or gaming environments to mimic individualized game play. Such games will eventually provide all users with all of the predefined gaming instances or gaming environments. Thus, these games provide a predetermined gaming experience independent of differences of the users, play style of the users, and other identifiable distinctive attributes or behaviors.

### BRIEF DESCRIPTION OF THE DRAWINGS

FIG. 1 is a schematic diagram showing an example of a system, according to some example embodiments.

FIG. 2 is a schematic diagram showing an example of a social network within a social graph, according to some embodiments.

FIG. 3 is a block diagram illustrating components of a computing device, according to some example embodiments.

FIG. 4 is a flowchart illustrating an example method for adaptively generating gaming instances, according to an example embodiment.

FIG. 5 is a user interface diagram depicting a graphical interface according to some example embodiments.

FIG. 6 is a user interface diagram depicting a graphical interface according to some example embodiments.

FIG. 7 is a user interface diagram depicting a graphical interface according to some example embodiments.

FIG. 8 is a user interface diagram depicting a graphical interface according to some example embodiments.

FIG. 9 is a flowchart illustrating an example method for adaptively generating gaming instances, according to an example embodiment.

FIG. 10 is a flowchart illustrating an example method for adaptively generating gaming instances, according to an example embodiment.

FIG. 11 is a user interface diagram depicting a graphical interface according to some example embodiments.

FIG. 12 is a user interface diagram depicting a graphical interface according to some example embodiments.

FIG. 13 is a diagrammatic representation of an example data flow between example components of the example system of FIG. 1, according to some example embodiments.

FIG. 14 illustrates an example computing system architecture, which may be used to implement a server or a client system illustrated in FIG. 13, according to some example embodiments.

FIG. 15 illustrates an example network environment, in which various example embodiments may operate.

### DETAILED DESCRIPTION

One aspect of the disclosure provides for a system, a machine-readable storage medium storing instructions, and a computer-implemented method for a game engine, such as a challenge engine, configured to adaptively generate gaming instances. The challenge engine may generate unique or customized gaming instances for each user of a gaming application employing the gaming engine. The unique or customized gaming instances may vary from player to player such that gaming instances are tailored or shifted according to behaviors of a given user. The gaming instances may be generated as challenges, tasks, or events within a graphical user interface of a game. The gaming instances may be tailored to users and unique or customized to each user for which a gaming instance is generated. For example, the gaming instances may be generated based on play behavior of a specified user and may incorporate differences in play style between users for which the challenge engine is generating gaming instances. The challenge engine may vary aspects or metrics of gaming instances based on past behavior of a user, playing style, a gaming environment in which the gaming instance is being generated, and based on desired game play attributes.

Some embodiments of the present disclosure describe a gaming interface or application presented on a user's computing device. For example, a user may open a gaming application on a smart phone. The gaming application may present a user interface with a series of rooms. The rooms may present differing games, gaming objectives, or game play types. The user may play a series of games within one or more of the rooms. Based on the user's play, the challenge engine may generate gaming instances within the rooms. As described in more detail below, each gaming instance may incorporate attributes of the gaming environment in which the gaming instance is generated. For example, where a room presents a slot machine having a specified theme, gaming instances generated for the slot machine room may include challenges, tasks, or events incorporating interaction with the slot machine within the room. The challenge engine may also incorporate thematic elements of the room by incorporating design elements, language, and other attributes of the room into the gaming instance.

As described in more detail below, in some embodiments, gaming instances provide a series of room-based or environment-based challenges for players of a gaming application. The gaming instances may provide a narrative experience for the player and include a narrative line. For example a gaming application involving thematic elements of WILLY WONKA AND THE CHOCOLATE FACTORY© may include a narrative line of “Wonka needs more ingredients!Spin 120 times in Tastes Like Blueberries.” Each time a challenge or gaming instance is completed, a new challenge or gaming instance may be created based on player metrics and definitions provided for challenge or gaming instance generation. The challenge definition data may include available challenge types, narrative templates, narrative options, available gaming environments, and available graphical symbols or icons. Challenge definition data may also include mapping of player metrics to difficulty attributes and rewards. In some embodiments, completion of a threshold number of challenges, embodiments of the present disclosure may generate rewards with incentive modifications, increasing a preexisting reward or providing new reward types. The incentive modifications may be mode based, such that completing the threshold number of challenges unlocks an increased incentive mode for a specified period of time.

### Social Network Systems and Game Networking Systems

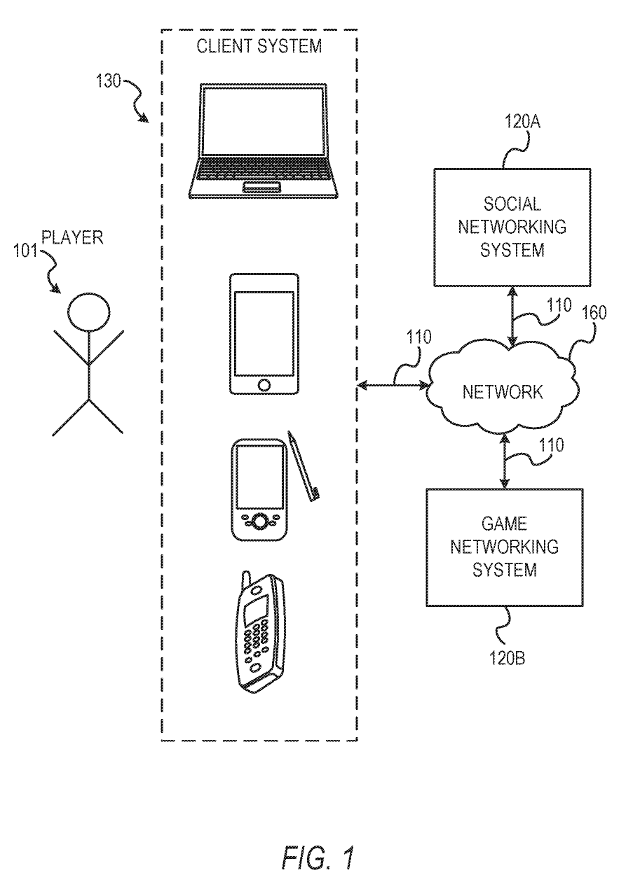

FIG. 1 illustrates an example of a system for implementing various disclosed embodiments. In particular embodiments, system 100 comprises player 101, social networking system 120a, game networking system 120b (i.e. online gaming system), client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 120a (i.e. social network system) is a network-addressable computing system that can host one or more social graphs. Social networking system 120a can generate, store, receive, and transmit social networking data. Social networking system 120a can be accessed by the other components of system 100 either directly or via network 160. Game networking system 120b is a network-addressable computing system that can host one or more online games. Game networking system 120b can generate, store, receive, and transmit game-related data, such as, for example, game account data, game input, game state data, and game displays. Game networking system 120b can be accessed by the other components of system 100 either directly or via network 160. Player 101 may use client system 130 to access, send data to, and receive data from social networking system 120a and game networking system 120b. Client system 130 can access social networking system 120a or game networking system 120b directly, via network 160, or via a third-party system. As an example and not by way of limitation, client system 130 may access game networking system 120b via social networking system 120a. Client system 130 can be any suitable computing device, such as a personal computer, laptop, cellular phone, smart phone, computing tablet, etc.

Although FIG. 1 illustrates a particular number of players 101, social network systems 120a, game networking systems 120b, client systems 130, and networks 160, this disclosure contemplates any suitable number of players 101, social network systems 120a, game networking systems 120b, client systems 130, and networks 160. As an example and not by way of limitation, system 100 may include one or more game networking systems 120b and no social networking systems 120a. As another example and not by way of limitation, system 100 may include a system that comprises both social networking system 120a and game networking system 120b. Moreover, although FIG. 1 illustrates a particular arrangement of player 101, social networking system 120a, game networking system 120b, client system 130, and network 160, this disclosure contemplates any suitable arrangement of player 101, social networking system 120a, game networking system 120b, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 120a, game networking system 120b, client system 130, and network 160, this disclosure contemplates any suitable connections between player 101, social networking system 120a, game networking system 120b, client system 130, and network 160. As an example and not by way of limitation, in particular embodiments, client system 130 may have a direct connection to social networking system 120a or game networking system 120b, bypassing network 160.

### Online Games and Game Systems

Game Networking Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120b (i.e. online gaming system), which includes a Notification Generator 150 that performs operations according to embodiments as described herein. The game networking system 120b can be accessed using any suitable connection with a suitable client system 130. A player may have a game account on game networking system 120b, wherein the game account can contain a variety of information associated with the player (e.g., the player's personal information, financial information, purchase history, player character state, game state). In some embodiments, a player may play multiple games on game networking system 120b, which may maintain a single game account for the player with respect to all the games, or multiple individual game accounts for each game with respect to the player. In some embodiments, game networking system 120b can assign a unique identifier to each player 101 of an online game hosted on game networking system 120b. Game networking system 120b can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmitting user inputs or other events to the game engine, and receive instructions from the game engine. The game engine can be executed on any suitable system (such as, for example, client system 130, social networking system 120a, or game networking system 120b). As an example and not by way of limitation, client system 130 can download client components of an online game, which are executed locally, while a remote game server, such as game networking system 120b, provides backend support for the client components and may be responsible for maintaining application data of the game, processing the inputs from the player, updating and/or synchronizing the game state based on the game logic and each input from the player, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 120b.

### Storing Game-Related Data

A database may store any data relating to game play within a game networking system 120b. The database may include database tables for storing a player game state that may include information about the player's virtual gameboard, the player's character, or other game-related information. For example, player game state may include virtual objects owned or used by the player, placement positions for virtual structural objects in the player's virtual gameboard, and the like. Player game state may also include in-game obstacles of tasks for the player (e.g., new obstacles, current obstacles, completed obstacles, etc.), the player's character attributes (e.g., character health, character energy, amount of coins, amount of cash or virtual currency, etc.), and the like.

The database may also include database tables for storing a player profile that may include user-provided player information that is gathered from the player, the player's client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

In some example embodiments, the player profile may also include derived player information that may be determined from other information stored in the database. The derived player information may include information that indicates the player's level of engagement with the virtual game, the player's friend preferences, the player's reputation, the player's pattern of game-play, and the like. For example, the game networking system 120b may determine the player's friend preferences based on player attributes that the player's first-degree friends have in common, and may store these player attributes as friend preferences in the player profile. Furthermore, the game networking system 120b may determine reputation-related information for the player based on user-generated content (UGC) from the player or the player's N^{th} degree friends (e.g., in-game messages or social network messages), and may store this reputation-related information in the player profile. The derived player information may also include information that indicates the player's character temperament during game play, anthropological measures for the player (e.g., tendency to like violent games), and the like.

In some example embodiments, the player's level of engagement may be indicated from the player's performance within the virtual game. For example, the player's level of engagement may be determined based on one or more of the following: a play frequency for the virtual game or for a collection of virtual games; an interaction frequency with other players of the virtual game; a response time for responding to in-game actions from other players of the virtual game; and the like.

In some example embodiments, the player's level of engagement may include a likelihood value indicating a likelihood that the player may perform a desired action. For example, the player's level of engagement may indicate a likelihood that the player may choose a particular environment, or may complete a new challenge within a determinable period of time from when it is first presented to him.

In some example embodiments, the player's level of engagement may include a likelihood that the player may be a leading player of the virtual game (a likelihood to lead). The game networking system 120b may determine the player's likelihood to lead value based on information from other players that interact with this player. For example, the game networking system 120b may determine the player's likelihood to lead value by measuring the other players' satisfaction in the virtual game, measuring their satisfaction from their interaction with the player, measuring the game-play frequency for the other players in relation to their interaction frequency with the player (e.g., the ability for the player to retain others), and/or the like.

The game networking system 120b may also determine the player's likelihood to lead value based on information about the player's interactions with others and the outcome of these interactions. For example, the game networking system 120b may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 120b may determine the player's likelihood to lead value based on determining a likelihood for the other players to perform a certain action in response to interacting or communicating with the player and/or the player's virtual environment.

### Game Systems, Social Networks, and Social Graphs:

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), etc. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player.

In particular embodiments, player 101 may access particular game instances of an online game. A game instance is copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players. A game instance is associated with a specific player when one or more game parameters of the game instance are associated with the specific player. As an example and not by way of limitation, a game instance associated with a first player may be named “First Player's Play Area.” This game instance may be populated with the first player's PC and one or more in-game objects associated with the first player. In particular embodiments, a game instance associated with a specific player may only be accessible by that specific player. As an example and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example and not by way of limitation, a first player may be associated with a first game instance, but the first game instance may be accessed by all first-degree friends in the first player's social network. In particular embodiments, the game engine may create a specific game instance for a specific player when that player accesses the game. As an example and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In particular embodiments, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example and not by way of limitation, a first player may be associated with Blackacre Farm in an online farming game. The first player may be able to plant crops on Blackacre Farm. If the first player accesses game instance associated with another player, such as Whiteacre Farm, the game engine may not allow the first player to plant crops in that game instance. However, other in-game actions may be available to the first player, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 120a or game networking system 120b). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 120b, which is managed by the game operator. In other embodiments, the social graph is part of a social networking system 120a managed by a third-party (e.g., Facebook, Friendster, Myspace). In yet other embodiments, player 101 has a social network on both game networking system 120b and social networking system 120a, wherein player 101 can have a social network on the game networking system 120b that is a subset, superset, or independent of the player's social network on social networking system 120a. In such combined systems, game network system 120b can maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

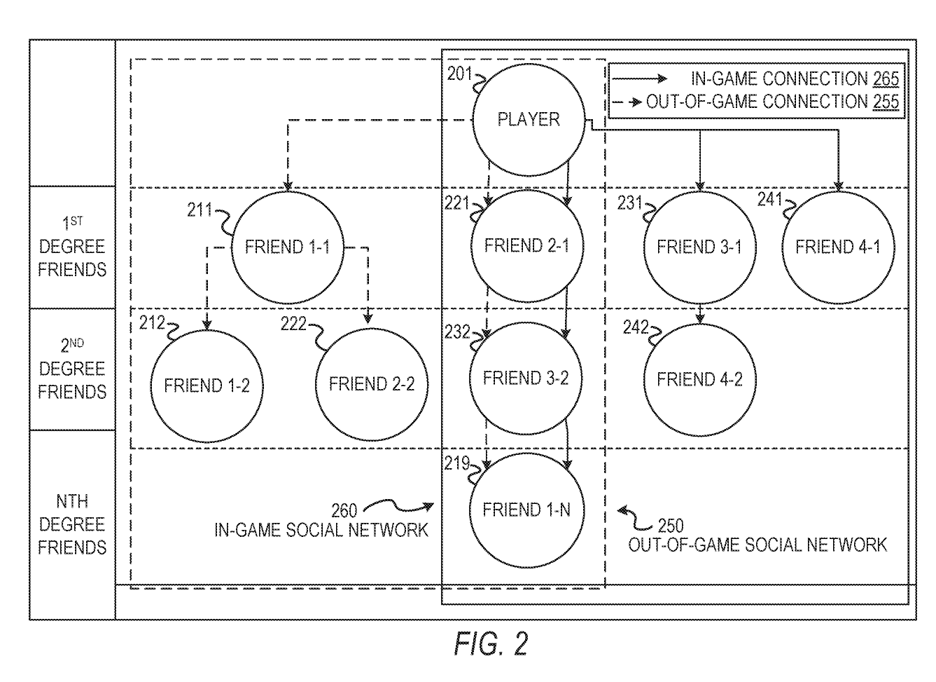

FIG. 2 shows an example of a social network within a social graph. As shown, Player 201 can be associated, connected or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player,” “user” and “account” can be used interchangeably and can refer to any user or character in an online game networking system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 120a.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

### Challenge Engine and Adaptive Properties

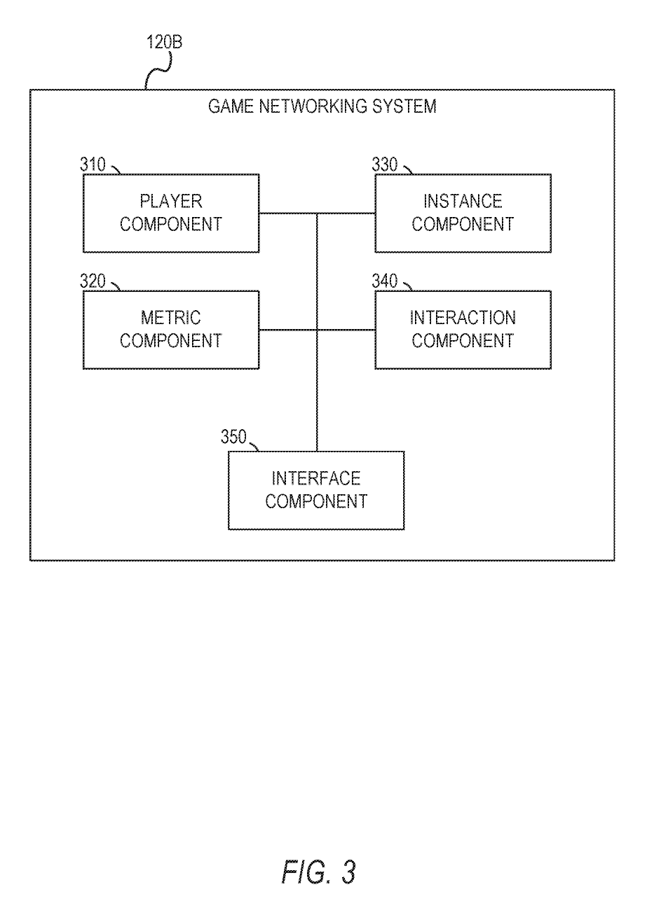

FIG. 3 is a block diagram illustrating components of a game networking system, according to some example embodiments. The game networking system 120b comprises the challenge engine. In some embodiments, the challenge engine comprises a player component 310, a metric component 320, an instance component 330, an interaction component 340, and an interface component 350. The player component 310 may maintain player identifications and metric categories for each player. The metric component 320 may detect, identify, and track player metrics for each player interacting with a gaming application or the challenge engine. The instance component 330 generates gaming instances based on one or more of player metrics, gaming environments, thematic elements, challenge definitions, reward definitions, time attributes, and other suitable information. The interaction component 340 detects and tracks player interactions within one or more of a gaming application, gaming environments, and generated gaming instances. The interface component 350 presents graphical user interfaces, icons, symbols, selectable graphical elements, and other depictions for the gaming application. In some embodiments, the interface component 350 detects intervening gaming instances which interrupt gaming instances generated for players.

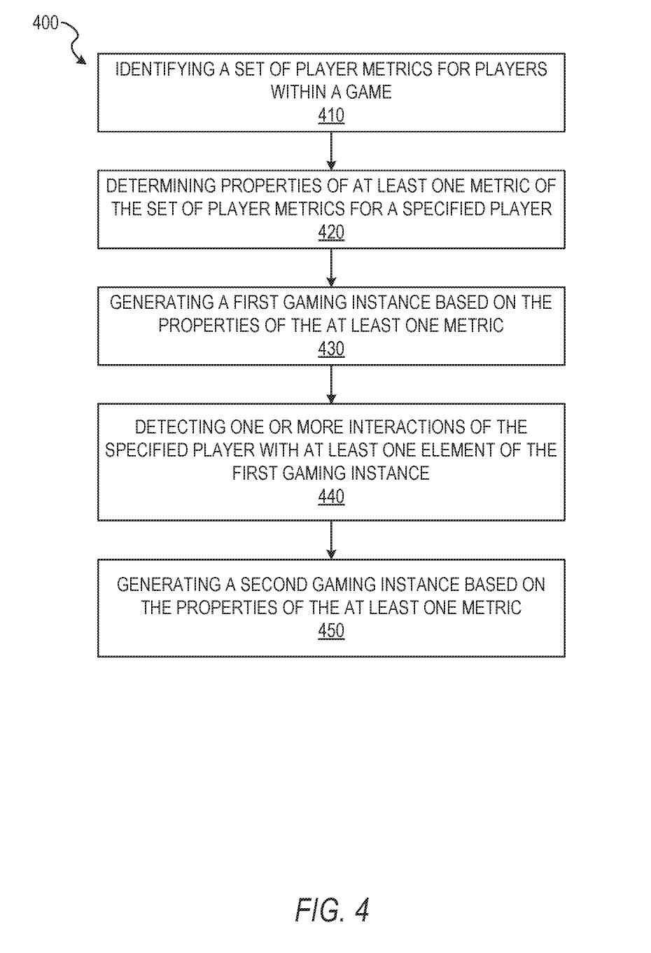

FIG. 4 is a flow chart illustrating an example method 400 for adaptively generating gaming instances according to some example embodiments.

In operation 410, the player component 310 identifies a set of player metrics for players within a game. The set of player metrics may be associated with a gaming application, one or more gaming environments (e.g., gaming environments corresponding to a gaming application), game play within the gaming application, game play specific to a mode of the gaming application, or any other suitable aspect of the gaming application. In some embodiments, the set of player metrics may include one or more of a play time, a number of interactions, a time of play (e.g., time of day, time of week, session or play duration, etc.), and any other suitable user metrics. At least a portion of the set of player metrics may be associated with elements, attributes, or themes of the gaming application, a gaming environment within the gaming application, or a gaming instance within one or more of a gaming environment or the gaming application. In some embodiments, the set of player metrics may include an number of spins, a number of spins per day or per session and per day, a number of wins (e.g., Jackpots, Bonus Wins, Awards, or Rewards), a number of wagers, a number of qualifying wagers (e.g., wagers above a specified threshold), a largest wager size (e.g., a largest wager size over a period of time), an average wager size (e.g., average wager size per play session, average wager size per session over a given period of time, or average wager size over a given period), a favorite or common wager size, a largest win, a frequency of wins, and any other suitable play or interaction metric. The set of player metrics may be collected over time (e.g., hourly, daily, semi-weekly, weekly, monthly, etc.), across a usage period (e.g., since installation of the gaming application), or any other suitable collection organization.

In operation 420, the metric component 320 determines properties of at least one metric of the set of player metrics for a specified player. The specified player may be one of the players of the game for which the set of player metrics are identified. In some embodiments, the properties may be identified from one or more user sessions of the specified player. The metric component 320 may determine properties of the at least one metric in response to initiating a gaming session. For example, where the specified player opens a gaming application and selects a gaming environment, the metric component 320 may identify one or more player metrics corresponding to the selected gaming environment and determine properties of the at least one metric matching the one or more player metrics of the gaming environment. By way of further example, a selected gaming environment may be associated with wagers. The metric component 320 may determine properties of one or more wager metrics for the specified player, such as a maximum wager, a frequency of wagers, or an average wager of the specified player.

In some embodiments, the at least one metric is a progress metric for a gaming environment. The interaction component 340 may detect one or more interactions within the gaming environment and identify a set of progress thresholds associated with the gaming environment. The interaction component 340 may determine one or more progress thresholds satisfied by the one or more interactions. For example, the at least one metric for the gaming environment may track progress for levels, tasks, play time, or other progressive metrics. The interaction component 340 may detect interactions during sessions or game play in a gaming environment and identify interactions which satisfy one or more of the set of progress thresholds, such as completing a level or task. Upon satisfying a progress threshold, the metric component 320 may determine properties of a metric associated with the progress threshold associated with the metric.

In operation 430, the instance component 330 generates a first gaming instance based on the properties of the at least one metric. In some embodiments, the first gaming instance is unique or customized to the specified player. The first gaming instance may be customized to the player by generating a customized first gameplay target, a first objective statement, and a first in-game benefit. The first objective statement may define the first gameplay target. In some embodiments, the first objective statement is a narrative content defining the challenge or the first gameplay target. The first in-game benefit may be a reward or other benefit awarded to the specified player upon satisfaction of the first gameplay target. The first gaming instance and attributes of the first gaming instance may be tailored to the specified player. For example, a difficulty level, available rewards, available incentives, a game play type, a challenge duration, and other suitable gaming instance attributes may be selected or generated based on the properties of the at least one metric of the specified player. The first gaming instance may include challenge attributes and rewards that are based on the specified player's behavior or average behavior, represented within the at least one metric. For example, initial challenges may be targeted to 20% of average player behavior for a day and rewards 5% of rewards for a given time period. By way of further example, if the specified player typically has 200 spins of a gaming wheel and is level 150, the first gaming instance may include a challenge, corresponding to existing gaming environments, starting with a 50 spin parameter. Incentive or reward modifications may also be included in gaming instances to increase rewards or incentivize certain interactions or interaction types. When a challenge of a gaming instance is completed, an incentive modification counter may be incremeneted and a reward assigned and displayed within the graphical user interface 500. If the incentive modification is active, as described in more detail below, additional rewards may be provided.

In some embodiments, once generated, the first gaming instance is generated, the instance component 330 may be transmitted to the computing device of the specified player as a key defining a gaming environment, a reward, and a challenge for the first gaming instance. The key may be passed to the computing device in a downloadable file to patch the gaming application. The key for given gaming instances may be stored on the computing device, such that offline play is available and each computing device may store its own gaming instances and progress. In some embodiments, the key includes challenge types from a challenge type array. The challenge type array defines a mapping between a set of challenge types, the set of player metrics, percentages of the player metrics for creating a target gaming instance, and a range for the percentages. The key may also include rewards from a reward type array. The reward type array may map a set of rewards, a set of available gaming environments, a set of symbols or icons, and the set of challenge types. The set of rewards may include payouts related to player metrics, payout percentages of the reward for the player metrics, payout frequencies, and incentive modification frequencies. The set of available gaming environments may include an array mapping environment names, icons or graphical symbols for use with specified environments, icon frequencies for presentation within the gaming environment, and challenge types associated with the gaming environments.

In some embodiments, a set of potential challenges are generated in a set of keys along with related key data. The key data may include a challenge type, a player metric needed, a percentage of player metric to use, and any data specific to gaming environments or portions of a gaming application related to the challenge type. When a gaming instance is to be generated, the instance component 330 may identify a key list to limit potential challenge keys from the set of keys. In some embodiments, the key list is selected from a key database or an experiment optimization service. The experiment optimization service or the instance component 330 may assign a weighting for a randomized choice or selection between keys within the set of keys which correspond to the key list. Once the key is selected, the instance component 330 uses player metric data associated with the selected challenge key to create the challenge of the first gaming instance. In some embodiments after generating the challenge, the instance component 330 generates a reward or other benefit to be accrued by the player for achieving the gameplay target of the first gaming instance. The reward may be generated in a manner similar to or the same as described above with respect to generating the challenge. The instance component 330 may combine the output of the challenge generation and the reward generation and transmit the resulting first gaming instance (e.g., a structured combination of the challenge or challenge definition and the reward or reward definition) to the mobile computing device of the specified player. The first gaming instance may include the objective statement or narrative content defining the challenge which is customized to the specified player based on the player metric data and the challenge generation process.

In an example gaming instance, the instance component 330 generates the first gaming instance to include a challenge of “Wonka is low on supplies! He needs you to find 30 Pieces of Chocolate in Augustus Under Pressure.” In generating the gaming instance of the example, the instance component 330 selects a symbol or icon challenge type (e.g., Collect Supplies), a gaming environment (e.g., Augustus Under pressure) available to the specified player from a gaming environment array, and an icon or symbol (e.g., a chocolate piece). The instance component 330 selects the above-referenced attributes based on a defined player metric identified within one or more of the arrays and a percentage of the player metric defined by the array. The instance component 330 may also identify a range or a randomized value for a range for the player metric. The instance component 330 may then select a version of a challenge to display, a reward or payout type, and a reward or payout amount.

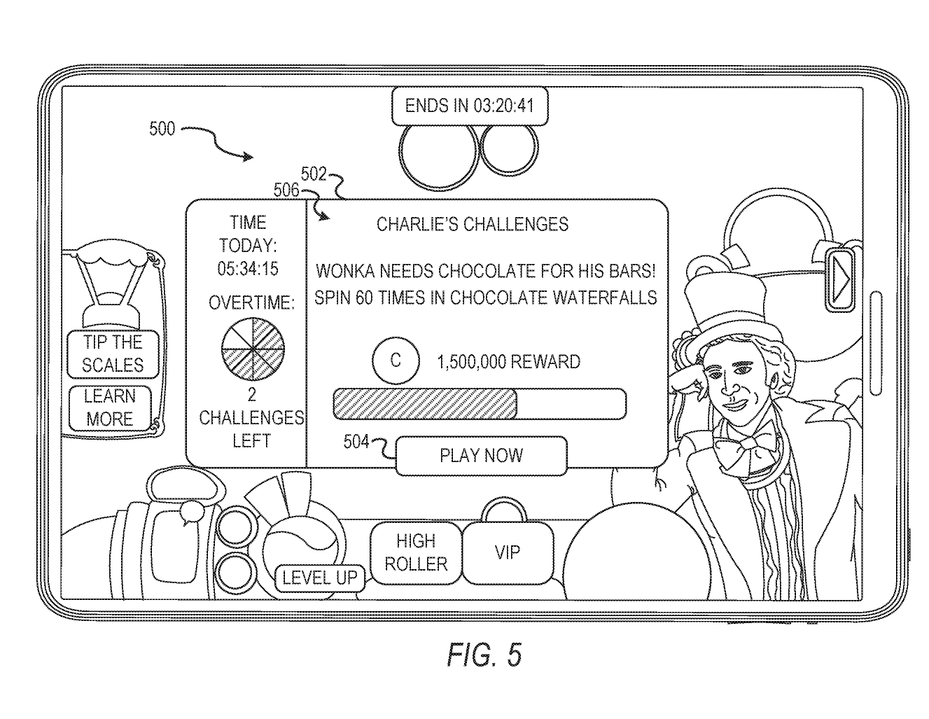

The instance component 330 may incorporate input from dynamic challenge definitions, dynamic reward definitions, reward modifiers, eligible gaming environment definitions, available thematic elements, player metrics, and any other suitable information to generate the first gaming instance. Dynamic challenge definitions may include player metrics based on percentages of a player's metrics, a randomized range of metrics of the specified player, a minimum metric target, or any other suitable player related data. Reward definitions may be associated with player metrics indicating previously achieved or earned rewards, cumulative rewards, minimum reward sizes, maximum reward sizes, time based rewards, reward types, and any other suitable reward related metrics. In embodiments where one or more progress thresholds are satisfied, the instance component 330 generates the first gaming instance based on the one or more interactions and the one or more progress thresholds satisfied by the one or more interactions. Gaming environment definitions may be selected from a list of icons or symbols available for a specified gaming environment. In some embodiments, gaming environments for which gaming instances may be generated contribute icons to populate the list of icons or symbols.

Where gaming instances are generated based on the properties of the at least one metric and a gaming environment (e.g., a room of a gaming application), the gaming instance may share thematic elements of the gaming environment, game play elements of the gaming environment, or other attributes of the gaming environment. For example, as shown in FIG. 5, a graphical user interface 500 for a gaming application may be presented at a computing device of the specified user. A first gaming instance 502 may be generated and presented within the graphical user interface 500. In some instances, as shown, the first gaming instance 500 is presented as a set of graphical elements, including a selectable interface element 504. Interaction with the selectable interface element 504 causes presentation of the first gaming instance 502. For example, when the specified user taps or otherwise selects the selectable interface element 504, the gaming application causes presentation of a game or portion of a game such as a slot machine.

As shown in FIG. 5, the first gaming instance 502 may include thematic elements of the gaming environment and the graphical user interface 500. For example, where the graphical user interface 500 contains thematic elements from WILLY WONKA AND THE CHOCOLATE FACTORY© or CHARLIE AND THE CHOCOLATE FACTORY©, the first gaming instance 502 may contain references, text, animations, images, or other thematic elements or depictions from the above-referenced works. As shown in FIG. 5, the set of graphical elements of the first gaming instance 502 include text referencing Charlie, Wonka, and a task or challenge relating to the characters and the gaming environment. The set of graphical elements of the first gaming instance 502 may also include information relating to a new challenge of the first gaming instance, a current challenge status (e.g., a regular challenge, an increased earning or incentive modified challenge, a progress indicator or bar, etc.), a completion status (e.g., currently complete or currently incomplete), and a reward status (e.g., rewards earned, extra or modified rewards earned, etc.), and any other suitable information in textual form, graphical form, or combinations thereof. In some embodiments, the set of graphical elements may be presented within a dialog element 506. In such embodiments, once the first gaming instance 502 and the dialog element 506 are generated, the instance component 330 or the interface component 350 may present additional information or graphical elements using state changes of the dialog element 506. The state changes may modify the information presented within the dialog element 506 based on player metrics, interactions with the first gaming instance 502, progress of the specified player within the challenge, or any other suitable information.

In some embodiments, the first gaming instance 502 and the set of graphical elements may be generated to include narrative elements, as referenced above. The instance component 330 may generate a narrative element for each gaming instance. The narrative element may be included in text within the set of graphical elements of the gaming instance. The narrative elements may define or describe the parameters of the challenge contained within the gaming instance. As shown, the narrative may place the specified player as a character (e.g., Charlie) and describe a challenge to be completed by the specified player. For example, the set of graphical elements may contain narrative text stating that the player is Charlie, training to run a chocolate factory, and describing the challenge of the gaming instance as “Wonka needs you to ‘X’,” where “X” includes a point total, a spin total, collection of a specified icon, or other suitable challenge parameter or threshold. Narrative elements or text may be selected from a set of narrative options. Once the challenge is generated, parameters of the challenge may be inserted or packaged within narrative elements or text selected from the set of narrative options. For example, the set of graphical elements may include narrative elements, with insertable challenge parameters such as “Wonka is running out of ingredients! Find ‘X’ (symbol name) in (room name),” “The Oompa Loompas are getting sleepy. Spin ‘X’ times in (room name) to wake them up,” “Wonka wants to test your skills. Win ‘X’ Credits in (room name) to prove yourself,” or other suitable text-based narrative combinations. In the examples above, “X” may include a number, “(symbol name)” may reference an icon or symbol which will, at least occasionally, appear in the gaming instance, and “(room name)” may reference a specified gaming environment for which the gaming instance is generated. Rooms or gaming environments on which gaming instances are based may include deep linking, such that narrative elements may be rooted in and correspond to dialog presented within the room or gaming environment.

The first gaming instance may be uniquely generated or generated in a customized manner for a first player, the specified player, of set of players of the game. The instance component 330 may determine properties of at least one metric for a second player of the set of players and generate at least one subsequent gaming instance (e.g., a third gaming instance) based on the properties of the at least one metric. The at least one subsequent gaming instance may be unique or customized to the second player. In some embodiments, the at least one metric used to generate gaming instances for the first player is a first metric and the at least one metric used to generate gaming instances for the second player is a second metric. The first metric may be distinct from the second metric.

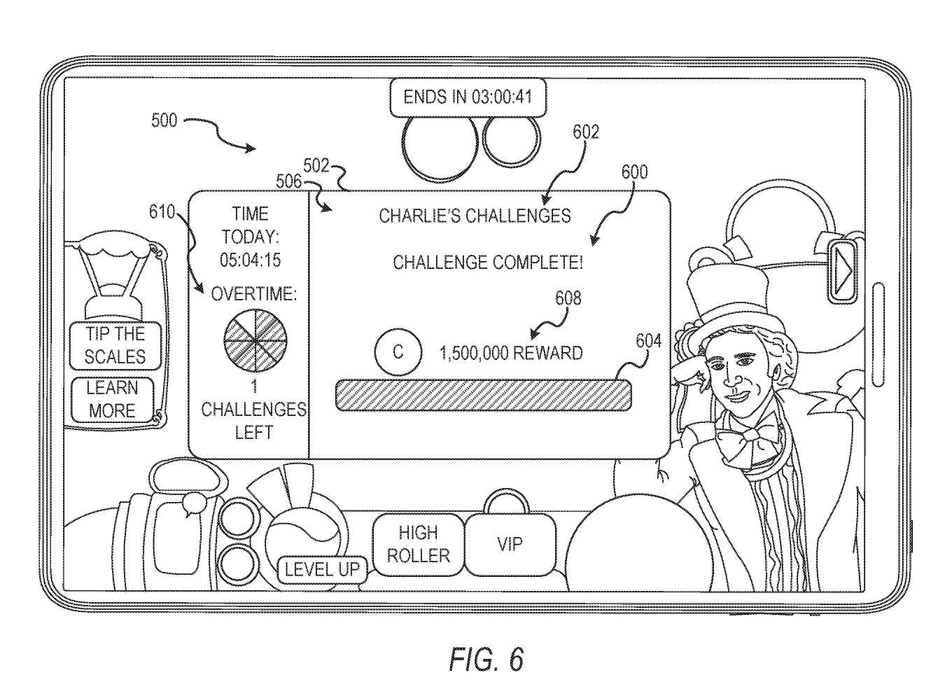

In operation 440, the interaction component 340 detects one or more interactions of the specified player with at least one element of the first gaming instance. The one or more interactions may include opening the first gaming instance, selecting one or more graphical interface elements depicted within the first gaming instance or a challenge within the first gaming instance, playing a game within the first gaming instance, or any other suitable interactions. As shown in FIG. 6, the one or more interactions may comprise a completion event. A notification 600 of the completion event may be displayed within the dialog element 506 of the graphical user interface 500. The notification 600 may comprise an identifier 602 for the challenge of the first gaming instance 502, a completion indicator 604 representing the one or more interactions comprising the completion event, and a reward indicator 608 representing a reward or incentive provided in response to the completion event. In some embodiments, the dialog element 506 includes an overtime notification 610 indicating a status or progress of an incentive modification mode. As shown, the progress within the overtime notification 610 may be displayed as a pie chart. However, it should be understood that the overtime notification 610 may display or represent progress in any discernable manner. The notification 600 may be displayed in response to the interaction component 340 detecting the one or more interactions comprising completion of the challenge or first gaming instance.

In some embodiments, the interaction component 340 detects the one or more interactions of the specified player as user interface selections or interactions with one or more input device associated with the computing device of the specified user. For example, the interaction component 340 may receive or detect signals generated at a touch screen from user contact with the touch screen, signals generated at a keyboard from user contact with one or more keys, signals generated at a navigation device (e.g., a mouse), or any other suitable user interaction with an input device. The interaction component 340 may interpret the interaction signals and resulting events within the first gaming instance to determine one or more player metrics, rewards, and progress of the specified player within the first gaming instance and the challenge associated with the first gaming instance.

In some embodiments, the interaction component 340 detects the one or more interactions of the specified player with the first gaming instance and an intervening period of time. For example, the player may interact with a challenge in the first gaming instance and repeatedly fail to complete the challenge. Upon detecting the intervening period of time, the interaction component 340 may pass a notification to the instance component 330 to cause the instance component 330 to generate a new gaming instance to replace or skip the first gaming instance. In some embodiments, the interaction component 340 detects one or more metrics indicating failure to complete or desire to skip a challenge of the first gaming instance. For example, the interaction component 340 may detect repeated interactions which indicate no progression through elements of the challenge or the first gaming instance. The interaction component 330 may detect interrupted interactions, such as frequent starts and stops or stops after pausing or failed progress. Upon detecting interactions that indicate no progress or progress below a challenge threshold, the interaction component 340 may pass a notification to the instance component 330 to cause the instance component 330 to generate a new gaming instance to replace or skip the first gaming instance.

The instance component 330 or the interface component 350 may present rewards based on the one or more interactions and cause presentation of reward notifications after the one or more interactions have been detected. In some embodiments, the rewards are assigned values based on one or more of a challenge completion status, a challenge progress, and an interaction metric (e.g., a wager amount, an average wager, etc.). The instance component 330 and the interface component 350 may present the rewards within the graphical user interface 500, the first gaming instance 502, within the dialog element 506, or any other suitable presentation.

In some embodiments, after one or more interactions have been performed by the specified player in interacting with the first gaming instance, the interaction component 340 and the instance component 330 generate a skip icon and incorporate the skip icon within the set of graphical elements of the first gaming instance 502. The skip icon may be presented as a selectable user interface element. Interaction with the skip icon may enable skipping or termination of the first gaming instance. The interaction component 340 may detect interaction with the skip icon and pass skip notification to the instance component 330. Receipt of the skip notification may cause the instance component 330 to generate a subsequent gaming instance.

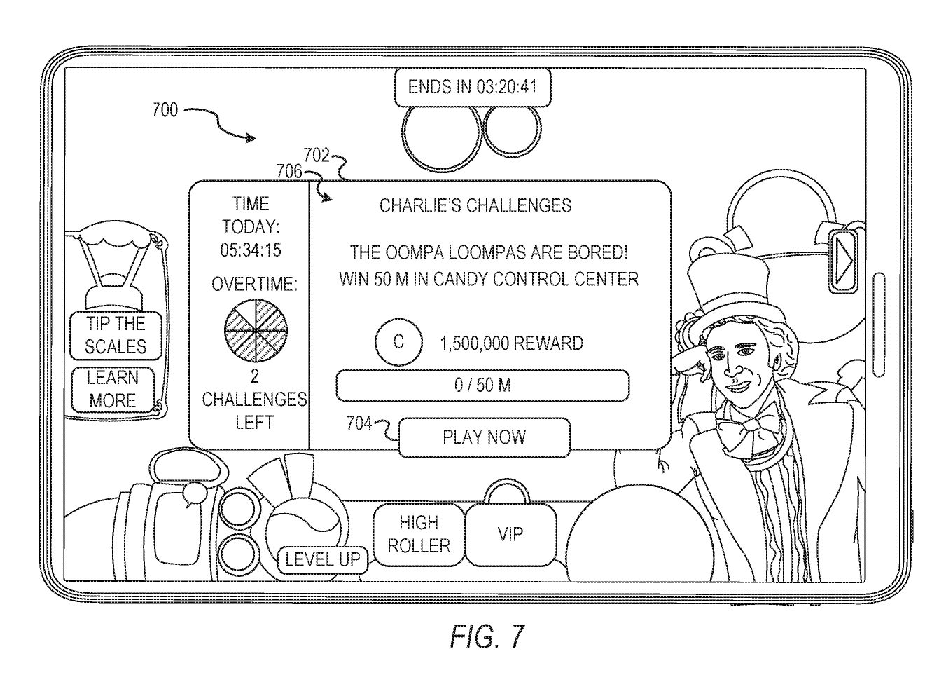

In operation 450, the instance component 330 generates a second gaming instance based on the properties of the at least one metric. The second gaming instance is generated in response to the one or more interactions. The second gaming instance may also be generated and displayed in response to presentation of the notification 600. As shown in FIG. 7, a graphical user interface 700 may be displayed in a manner substantially similar to or the same as described above with respect to FIG. 5. The graphical user interface 700 may comprise a representation of the second gaming instance 702 and a selectable interface element 704. The selectable interface element 704 may enable selection and interaction with the second gaming instance 702. The representation of the second gaming instance 702 may also include a dialog element 706 presenting information defining or describing the second gaming instance 702. In some embodiments, the dialog element 706 is presented in a manner similar to or the same as described above with respect to the dialog element 506 of FIG. 5.

The second gaming instance may be distinct from the first gaming instance, such that a same challenge, task, game play, or type is not generated in successive challenges. In some embodiments, the second gaming instance unique or customized to the specified player and distinct from the first gaming instance. In some embodiments, the first gaming instance is unique or customized to the specified player. The second gaming instance may be customized to the player by generating a customized second gameplay target, a second objective statement, and a second in-game benefit. The second objective statement may define the second gameplay target. In some embodiments, the second objective statement is a narrative content defining the challenge or the second gameplay target. The second in-game benefit may be a reward or other benefit awarded to the specified player upon satisfaction of the second gameplay target. Although described as a second gaming instance, it should be understood that the instance component 330 may generate any suitable number of successive or contemporaneous gaming instances. For example, each time a challenge of a gaming instance is completed, the instance component 330 may generate a new gaming instance. As such, the instance component 330 may effectively generate and present an infinite or theoretically infinite number of gaming instances to present a new challenge or instance once a previous instance is completed. In some embodiments, a set of graphical elements associated with the second gaming instance or a subsequent gaming instance identifies a number of gaming instances completed within a predetermined time period (e.g., gaming instances completed in the last day, the last week, the last month, etc.).

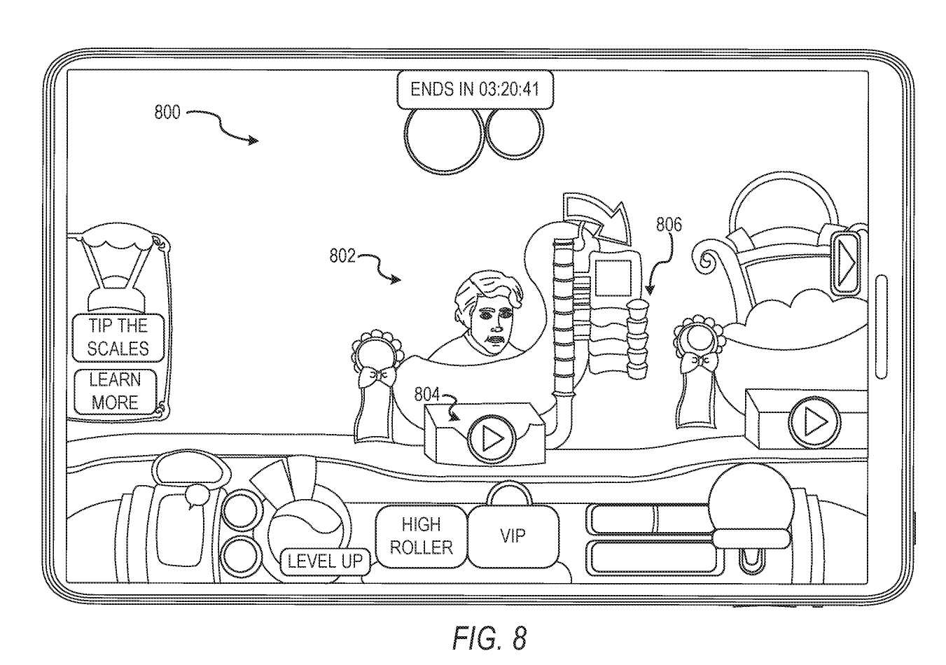

In some embodiments, the interface component 350 is configured to detect an intervening gaming instance. Detection of intervening gaming instances may be performed at any time a gaming instance, having precedence over a newly generated gaming instance, occurs. For example, the interface component 250 may detect an intervening gaming instance upon generation of the second gaming instance by the instance component 330. As shown in FIG. 8, in some embodiments, disabled gaming instances or gaming instances not currently being accessed may be presented within a graphical user interface 800. The graphical user interface 800 may present one or more selectable interface elements 802 and a representation of a gaming environment 804. In association with the representation of the gaming environment 804, the interface component 350 may present a set of instance icons 806. Each instance icon 806 may represent a gaming instance available for interaction. In some embodiments, the set of instance icons 806 represent both active gaming instances and disabled gaming instances.

In response to detecting the intervening gaming instance, the interface component 350 may disable the second gaming instance. Disabling of the second gaming instance may temporarily turn off the second gaming instance to prioritize another gaming instance (e.g., the intervening gaming instance). While the second gaming instance is disabled, the second gaming instance is maintained or stored, such that the second gaming instance may be reinitiated or restored to an active status during which a user may interact with the second gaming instance. In addition to maintaining or saving the second gaming instance, the interaction component 340 or the interface component 350 may store or maintain progress records for the second gaming instance. The progress records may include progress or interactions performed within the second gaming instances, progress or interactions corresponding to creation of the second gaming interface (e.g., a play history or other player metrics), and any other suitable interaction information. In some instances the progress records may include information relating to previously generated or presented gaming instances, such as the first gaming instance. The second gaming instance may be disabled at a moment or substantially contemporaneous to generation, receipt, or presentation of the intervening gaming instance. For example, when an event begins for the gaming application (e.g., an update or a predetermined challenge scheduled for a specified time), the second gaming instance may be disabled at the same time as the event.

The interaction component 340 may detect one or more interactions with the intervening gaming instance detected by the interface component 350. In some embodiments, the one or more interactions represent the specified player interacting with the intervening gaming instance. The interaction may result in completion of at least a portion of the intervening gaming interface. Once the one or more interactions have been detected, the interaction component 340 and the interface component 350 may resume, start, or otherwise cause presentation of the second gaming instance in response to completion of the intervening gaming instance. When the event terminates or the intervening gaming instance is completed, the second gaming instance may be automatically reenabled or restarted. In some embodiments, in addition to restarting the second gaming instance, the interaction component 340 may iterate or otherwise modify the progress record to include data representing completion of the intervening gaming instance.

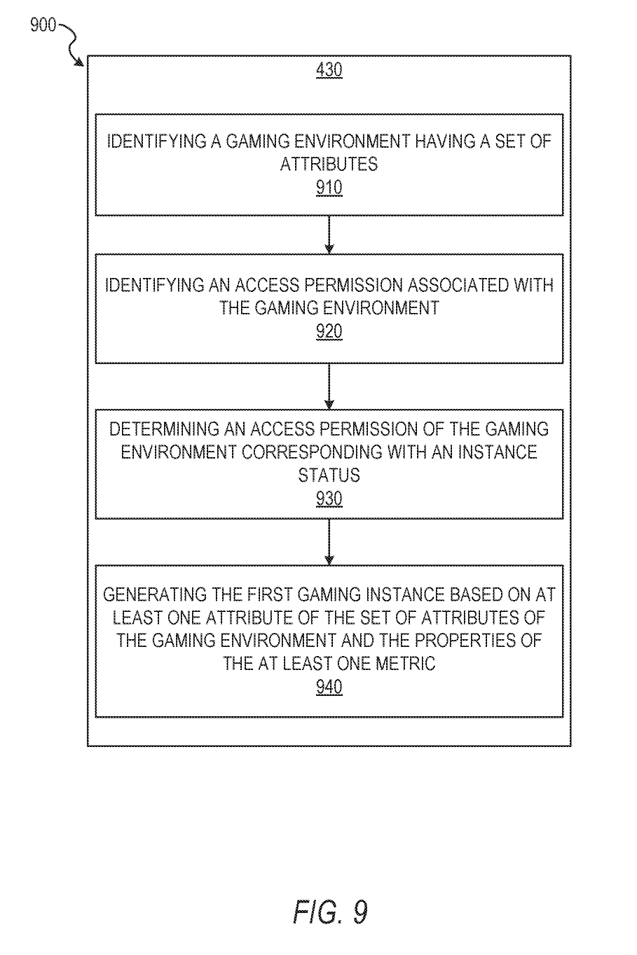

FIG. 9 is a flowchart illustrating an example method 900 for adaptively generating gaming instances according to some example embodiments. Operations of the method 900 may be performed in combination with, as part of, or as sub-operations of the method 400. As shown in FIG. 9, operations of the method 900 may be performed as sub-operations of method 400 and operation 430, in some embodiments.

In operation 910, the instance component 330 identifies a gaming environment having a set of attributes. As described above, the gaming environments may be rooms, games, or other distinct (e.g., thematically distinct or having distinct game play attributes) operating environments accessible within the gaming application. The gaming environment may be identified as a gaming environment from a set of gaming environments within the gaming application. The instance component 330 may identify the gaming environment based on selection of the specified player, a notification of the game networking system 120b, or any other suitable prompt, interaction, or triggering event.

In operation 920, the instance component 330 identifies an access permission associated with the gaming environment. The access permissions for the gaming environments may represent an access control for the gaming environment, a status of the gaming environment, or other suitable access permission. In some embodiments, the access permission for the gaming environment indicates a temporal status of the gaming environment. For example, the access permission may indicate that the gaming environment is temporary or a preview of the gaming environment. In some embodiments, the access permission of the gaming environment indicates a lock status of the gaming environment. For example, the access permission may indicate that the gaming environment is locked or unlocked based on the set of player metrics for the specified player.

In operation 930, the instance component 330 determines an access permission of the gaming environment corresponding with an instance status. The instance status may indicate a request or notification for generating a gaming instance for the gaming environment. In embodiments where the access permission indicates a preview or temporary gaming environment, the access permission may include an attribute prohibiting generation of gaming instances for the gaming environment. Similarly, in embodiments where the access permission indicates a locked gaming environment, the access permission may include an attribute prohibiting generation of gaming instances for the gaming environment. Where the access permission is determined to indicating a temporary, preview, or locked gaming environment, the instance component 330 may determine instance component 330 determine that the access permission and the instance status are mismatched. Where the access permission is determined to indicate a permanent, available, or unlocked gaming environment, the instance component 330 determines that the access permission corresponds to the instance status.

In operation 940, the instance component 330 generates the first gaming instance based on at least one attribute of the set of attributes of the gaming environment and the properties of the at least one metric. In some embodiments, the instance component 330 generates the first gaming instance based on the access permission matching the instance status. The first gaming instance may be generated in a manner similar to or the same as described above with respect to FIGS. 4 and 5.

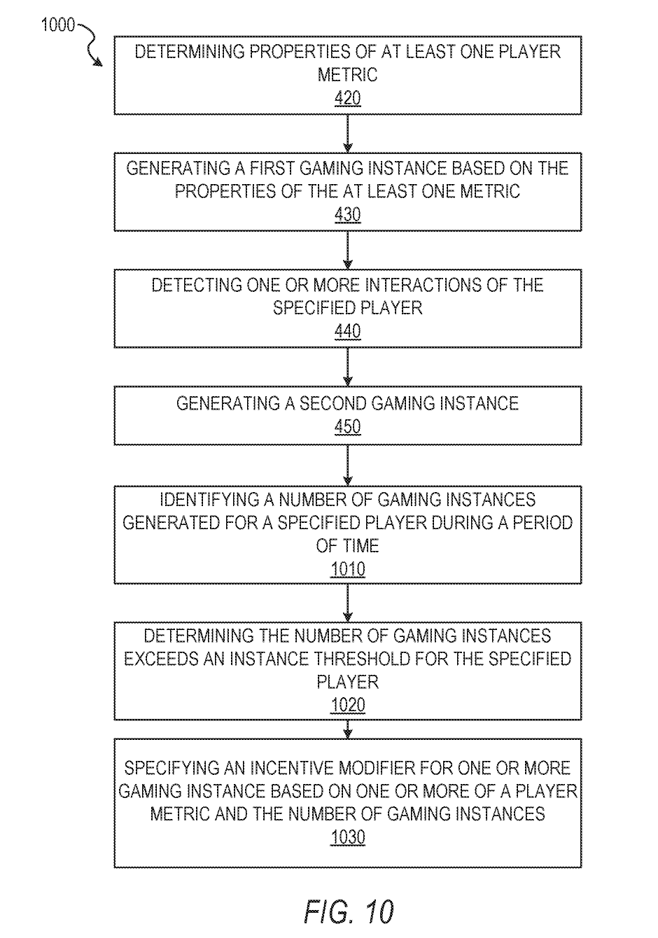

FIG. 10 is a flowchart illustrating an example method 1000 for adaptively generating gaming instances according to some example embodiments. Operations of the method 1000 may be performed in combination with, as part of, or as sub-operations of the methods 400 or 900. In some embodiments, the method 1000 may be performed during or after the operations of the method 400.

In operation 1010, the instance component 330 identifies a number of gaming instances generated for the specified player during a predetermined period of time. The number of gaming instances may be identified from the progress record, the set of player metrics for the specified player, or any other suitable information. In some embodiments, the instance component 330 accesses data representing game play or user interactions with the gaming application described above. From the data, the instance component 330 may determine, select, or otherwise identify data pertaining to gaming instances generated for the specified player. In some embodiments, the instance component 330 determines data pertaining to gaming instances generated for the specified player which have been completed. For example, the instance component 330 may identify the number of gaming instances generated for the specified player in response to completion of the second gaming instance 702 displayed in FIG. 7.

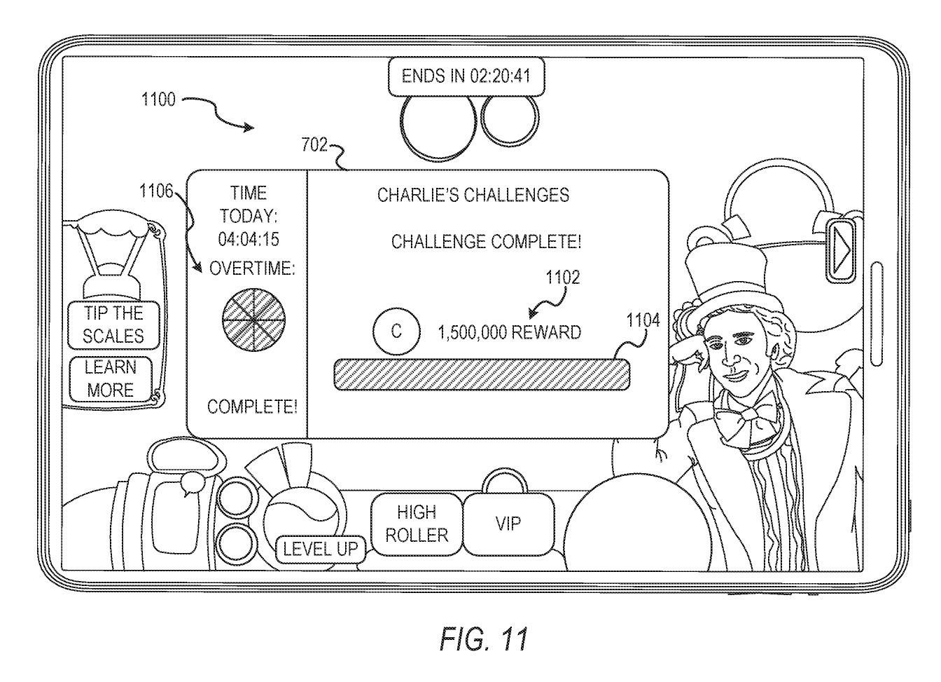

In operation 1020, the instance component 330 determines the number of gaming instances exceeds an instance threshold for the specified player. For example, as shown in FIG. 11, the instance component 330 may identify completion of the second gaming instance 702 in response to a completion event and display of a graphical user interface 1100 including a completion notification 1102, as shown in FIG. 11. The completion notification 1102 may comprise a first indicator 1104 representing completion of the second gaming instance 702 and a second indicator 1106 representing the completed second gaming instance satisfying the instance threshold.

In some embodiments, the instance threshold is a predetermined threshold. In such embodiments, the instance threshold may be set by the gaming application or one or more components of the challenge engine. The instance threshold may also be set by the game networking system 120b and transmitted to the computing device of the specified player. The predetermined threshold may be based on one or more of a time attribute (e.g., a number of gaming instances per day, a number of gaming instances per week, etc.). The predetermined threshold may also be based on one or more of a player level, a frequency of play, a frequency of gaming interaction completion, or any other suitable player metric. In some embodiments, the instance threshold may be dynamically generated based on the set of player metrics, a time attribute (e.g., a time of day, a number of gaming instances per day, etc.). The instance component 330 may determine the number of gaming instances exceeds the instance threshold by comparing a numeric value of the number of gaming instances generated for the player with a numeric value for the instance threshold.

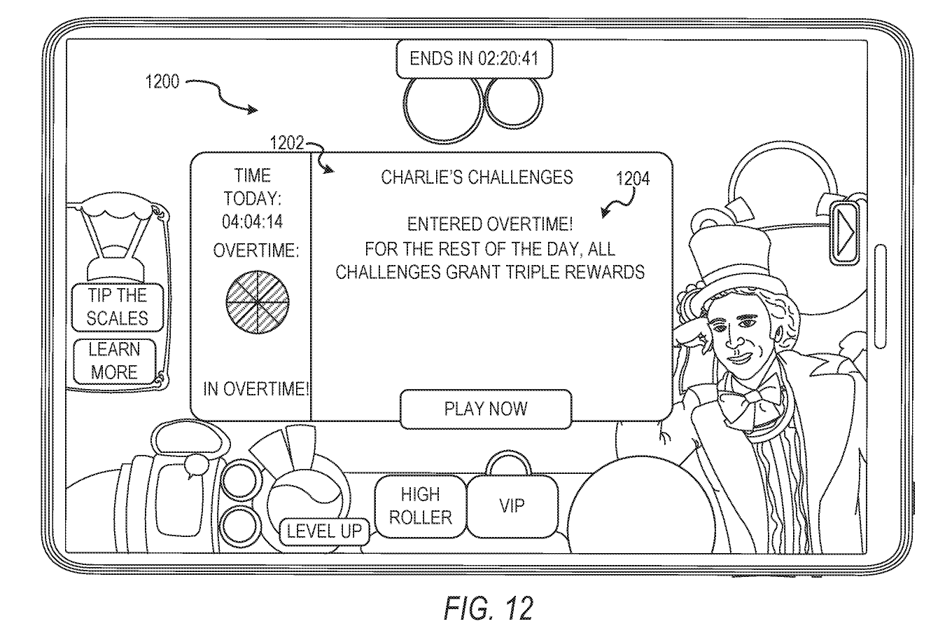

In operation 1030, the instance component 330 specifies an incentive modifier 1204 for one or more of the first gaming instance and the second gaming instance. In some embodiments, the incentive modifier 1204 is specified in a graphical user interface 1200 and within a dialog element 1202, as shown in FIG. 12. The incentive modifier 1204 may represent an increase in incentives or rewards for completing subsequent gaming instances. Each challenge, gaming instance, or other play session may generate rewards, and upon activation, the incentive modifier may be applied to those rewards. For example, exceeding the instance threshold may cause the instance component 330 to place the gaming application into an extra earnings mode, increasing incentives or rewards received by the specified player for performing tasks, challenges, or other interactions with one or more of the gaming application, the gaming environments, and the gaming instances. In some embodiments, the incentive modifier is applied to gaming instances, gaming environments, or other game play within the gaming application for a predetermined period of time or a dynamically determined period of time. For example, the incentive modifier may be applied for a twenty-four hour period or a twelve hour period immediately following the instance component 330 determining the number of gaming instances, previously generated, exceeds the instance threshold. Upon termination of the period for the incentive modifier (e.g., identifying midnight of a specified day), the instance component 330 may reset the incentive modifier to a previous level or normal level. In some embodiments, the instance component 330 temporarily disables the incentive modifier at the termination of the time period.

Upon specifying the incentive modifier, the instance component 330 may generate and present a representation of the instance modifier. The representation of the instance modifier may be presented with or in addition to the set of graphical elements of a current gaming instance (e.g., the first gaming instance or the second gaming instance). The representation of the instance modifier may be text based (e.g., a portion of text describing the incentive modifier) or graphically based (e.g., a star, a bell, or other icon representation of the incentive modifier).

As described above, in some embodiments when an intervening gaming instance is detected, the incentive modifier may be disabled during pendency of the intervening gaming instance. The incentive modifier may be reinitialized, reenabled, or reapplied upon completion or termination of the intervening gaming instance.

### Data Flow

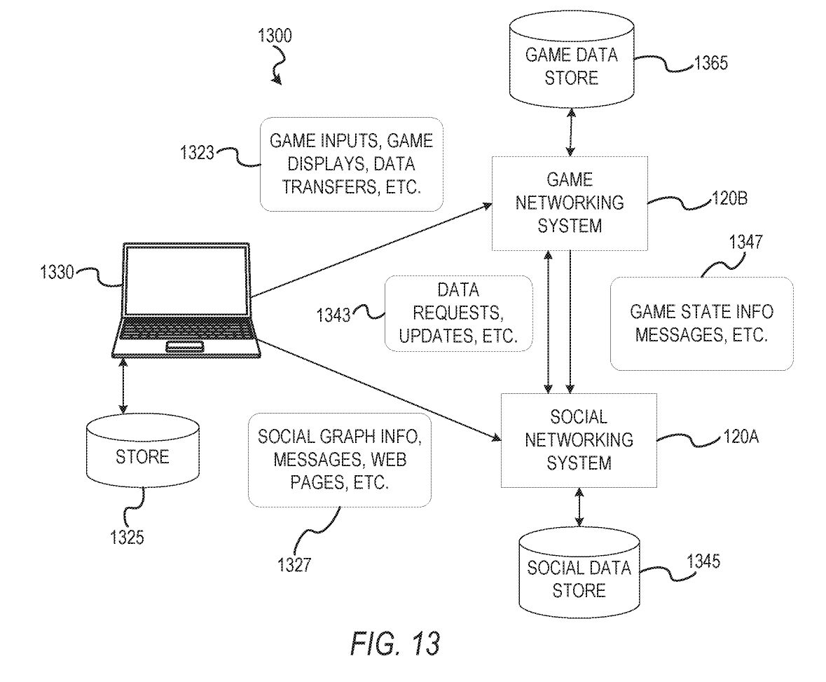

FIG. 13 illustrates an example data flow between the components of system 1300. In particular embodiments, system 1300 can include client system 1330, social networking system 120a (i.e. social network system), and game networking system 120b (i.e. online game system system). The components of system 1300 can be connected to each other in any suitable configuration, using any suitable type of connection. The components may be connected directly or over any suitable network. Client system 1330, social networking system 120a, and game networking system 120b can each have one or more corresponding data stores such as local data store 1335, social data store 1345, and game data store 1365, respectively. Social networking system 120a and game networking system 120b can also have one or more servers that can communicate with client system 1330 over an appropriate network. Social networking system 120a and game networking system 120b can have, for example, one or more internet servers for communicating with client system 530 via the Internet. Similarly, social networking system 120a and game networking system 120b can have one or more mobile servers for communicating with client system 1330 via a mobile network (e.g., GSM, PCS, Wi-Fi, WPAN, etc.). In some embodiments, one server may be able to communicate with client system 530 over both the Internet and a mobile network. In other embodiments, separate servers can be used.

Client system 1330 can receive and transmit data 1323 to and from game networking system 120b. This data can include, for example, webpages, messages, game inputs, game displays, HTTP packets, data requests, transaction information, updates, and other suitable data. At some other time, or at the same time, game networking system 120b can communicate data 1343, 1347 (e.g., game state information, game system account information, page info, messages, data requests, updates, etc.) with other networking systems, such as social networking system 120a (e.g., Facebook, Myspace, etc.). Client system 1330 can also receive and transmit data 1327 to and from social networking system 120a. This data can include, for example, webpages, messages, social graph information, social network displays, HTTP packets, data requests, transaction information, updates, and other suitable data.

Communication between client system 1330, social networking system 120a, and game networking system 120b can occur over any appropriate electronic communication medium or network using any suitable communications protocols. For example, client system 1330, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTPS, FTP, SNMP, TELNET, and a number of other protocols, may be used. In some embodiments, no protocol may be used and, instead, transfer of raw data may be utilized via TCP or User Datagram Protocol. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 120b, the BLOB containing the game state for the instance corresponding to the player can be transmitted to client system 1330 for use by a client-side executed object to process. In particular embodiments, the client-side executable may be a FLASH-based game, which can de-serialize the game state data in the BLOB. As a player plays the game, the game logic implemented at client system 1330 maintains and modifies the various game state parameters locally. The client-side game logic may also batch game events, such as mouse clicks, and transmit these events to game networking system 120b. Game networking system 120b may itself operate by retrieving a copy of the BLOB from a database or an intermediate memory cache (memcache) layer. Game networking system 120b can also de-serialize the BLOB to resolve the game state parameters and execute its own game logic based on the events in the batch file of events transmitted by the client to synchronize the game state on the server side. Game networking system 120b may then re-serialize the game state, now modified, into a BLOB and pass this to a memory cache layer for lazy updates to a persistent database.

With a client-server environment in which the online games may run, one server system, such as game networking system 120b, may support multiple client systems 1330. At any given time, there may be multiple players at multiple client systems 1330 all playing the same online game. In practice, the number of players playing the same game at the same time may be very large. As the game progresses with each player, multiple players may provide different inputs to the online game at their respective client systems 1330, and multiple client systems 1330 may transmit multiple player inputs and/or game events to game networking system 120b for further processing. In addition, multiple client systems 1330 may transmit other types of application data to game networking system 120b.

In particular embodiments, a computed-implemented game may be a text-based or turn-based game implemented as a series of web pages that are generated after a player selects one or more actions to perform. The web pages may be displayed in a browser client executed on client system 1330. As an example and not by way of limitation, a client application downloaded to client system 1330 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF object that is embedded in a web page and executable by a Flash media player plug-in. In particular embodiments, one or more described webpages may be associated with or accessed by social networking system 120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 1330, either caused by an action of a game player or by the game logic itself, client system 1330 may need to inform game networking system 120b of the update. For example, if the game is a farming game with a harvest mechanic (such as Zynga FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 1300 is discussed in reference to updating a multi-player online game hosted on a network-addressable system (such as, for example, social networking system 120a or game networking system 120b), where an instance of the online game is executed remotely on a client system 1330, which then transmits application event data to the hosting system such that the remote game server synchronizes game state associated with the instance executed by the client system 1330.

In particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 1330 may include a Flash client. The Flash client may be configured to receive and run Flash application or game object code from any suitable networking system (such as, for example, social networking system 120a or game networking system 120b). In particular embodiments, the Flash client may be run in a browser client executed on client system 1330. A player can interact with Flash objects using client system 1330 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 1330, the Flash client may send the events that caused the game state changes to the in-game object to game networking system 120b. However, to expedite the processing and hence the speed of the overall gaming experience, the Flash client may collect a batch of some number of events or updates into a batch file. The number of events or updates may be determined by the Flash client dynamically or determined by game networking system 120b based on server loads or other factors. For example, client system 1330 may send a batch file to game networking system 120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 1330. In particular embodiments, the batch file may be a text file and the name-value pairs may be in string format.

In particular embodiments, when a player plays an online game on client system 1330, game networking system 120b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 120b may retrieve the corresponding BLOB from the database to determine the most-recent values of the game-related data. In particular embodiments, while a player is playing the online game, game networking system 120b may also load the corresponding BLOB into a memory cache so that the game system may have faster access to the BLOB and the game-related data contained therein.

### Systems

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

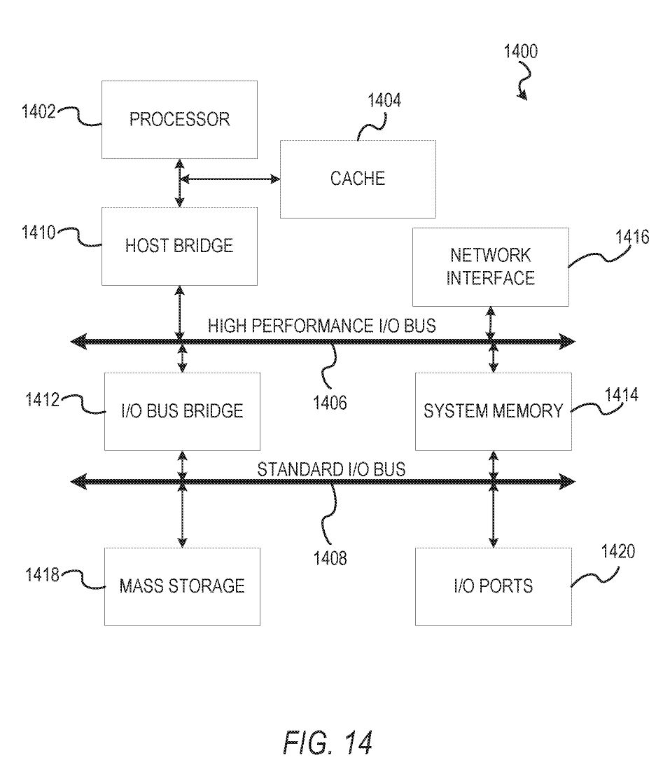

FIG. 14 illustrates an example computing system architecture, which may be used to implement a server 1322 or a client system 1330 illustrated in FIG. 13. In one embodiment, hardware system 1400 comprises a processor 1402, a cache memory 1404, and one or more executable modules and drivers, stored on a tangible computer readable medium, directed to the functions described herein. Additionally, hardware system 1400 may include a high performance input/output (I/O) bus 1406 and a standard I/O bus 1408. A host bridge 1410 may couple processor 1402 to high performance I/O bus 1406, whereas I/O bus bridge 1412 couples the two buses 1406 and 1408 to each other. A system memory 1414 and one or more network/communication interfaces 1416 may couple to bus 1406. Hardware system 1400 may further include video memory (not shown) and a display device coupled to the video memory. Mass storage 1418 and I/O ports 1420 may couple to bus 1408. Hardware system 1400 may optionally include a keyboard, a pointing device, and a display device (not shown) coupled to bus 1408. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 1400 are described in greater detail below. In particular, network interface 1416 provides communication between hardware system 1300 and any of a wide range of networks, such as an Ethernet (e.g., IEEE 802.3) network, a backplane, etc. Mass storage 1418 provides permanent storage for the data and programming instructions to perform the above-described functions implemented in servers 822, whereas system memory 1414 (e.g., DRAM) provides temporary storage for the data and programming instructions when executed by processor 1402. I/O ports 1420 are one or more serial and/or parallel communication ports that provide communication between additional peripheral devices, which may be coupled to hardware system 1400.

Hardware system 1400 may include a variety of system architectures and various components of hardware system 1400 may be rearranged. For example, cache 1404 may be on-chip with processor 1402. Alternatively, cache 1404 and processor 1402 may be packed together as a “processor module,” with processor 1402 being referred to as the “processor core.” Furthermore, certain embodiments of the present disclosure may not require nor include all of the above components. For example, the peripheral devices shown coupled to standard I/O bus 1408 may couple to high performance I/O bus 1406. In addition, in some embodiments, only a single bus may exist, with the components of hardware system 1400 being coupled to the single bus. Furthermore, hardware system 1400 may include additional components, such as additional processors, storage devices, or memories.

An operating system manages and controls the operation of hardware system 1400, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit. Particular embodiments may operate in a wide area network environment, such as the Internet, including multiple network addressable systems.

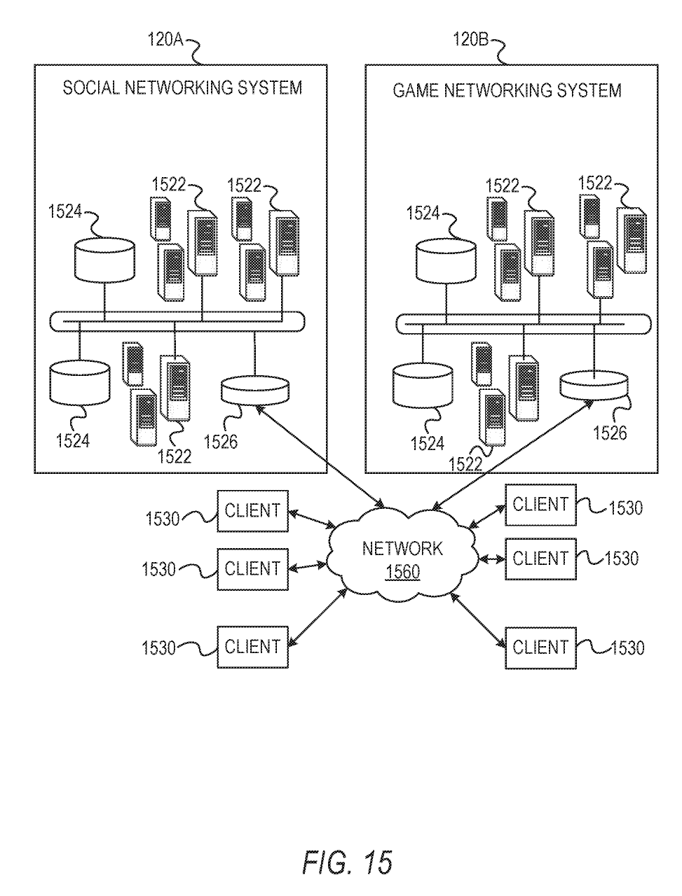

FIG. 15 illustrates an example network environment, in which various example embodiments may operate. Network cloud 1560 generally represents one or more interconnected networks, over which the systems and hosts described herein can communicate. Network cloud 1560 may include packet-based wide area networks (such as the Internet), private networks, wireless networks, satellite networks, cellular networks, paging networks, and the like. As FIG. 15 illustrates, particular embodiments may operate in a network environment comprising one or more networking systems, such as social networking system 120a, game networking system 120b, and one or more client systems 1530. The components of social networking system 120a and game networking system 120b operate analogously; as such, hereinafter they may be referred to simply at networking system 1520. Client systems 1530 are operably connected to the network environment via a network service provider, a wireless carrier, or any other suitable means.

Networking system 120 is a network addressable system that, in various example embodiments, comprises one or more physical servers 1522 and data stores 1524. The one or more physical servers 1522 are operably connected to computer network 1560 via, by way of example, a set of routers and/or networking switches 1526. In an example embodiment, the functionality hosted by the one or more physical servers 1522 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 1522 may host functionality directed to the operations of networking system 1520. Hereinafter servers 1522 may be referred to as server 1522, although server 1522 may include numerous servers hosting, for example, networking system 1520, as well as other content distribution servers, data stores, databases and cloud computing systems. Data store 1524 may store content and data relating to, and enabling, operation of networking system 1520 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Logically, data store 1524 corresponds to one or more of a variety of separate and integrated databases, such as relational databases and object-oriented databases, that maintain information as an integrated collection of logically related records or files stored on one or more physical systems. Structurally, data store 1524 may generally include one or more of a large class of data storage and management systems. In particular embodiments, data store 1524 may be implemented by any suitable physical system(s) including components, such as one or more database servers, mass storage media, media library systems, storage area networks, data storage clouds, and the like. In one example embodiment, data store 1524 includes one or more servers, databases (e.g., MySQL), and/or data warehouses. Data store 1524 may include data associated with different networking system 1520 users and/or client systems 1530.

Client system 1530 is generally a computer or computing device including functionality for communicating (e.g., remotely) over a computer network. Client system 1530 may be a desktop computer, laptop computer, personal digital assistant (PDA), in- or out-of-car navigation system, smart phone or other cellular or mobile phone, or mobile gaming device, among other suitable computing devices. Client system 1530 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 1530 to enter addresses of specific network resources to be retrieved, such as resources hosted by networking system 1520. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 1530 desires to view a particular webpage (hereinafter also referred to as target structured document) hosted by networking system 1520, the user's web browser, or other document Sequence Generator or suitable client application, formulates and transmits a request to networking system 1520. The request generally includes a URL or other document identifier as well as metadata or other information. By way of example, the request may include information identifying the user, such as a user ID, as well as information identifying or characterizing the web browser or operating system running on the user's client computing device 1530. The request may also include location information identifying a geographic location of the user's client system or a logical network location of the user's client system. The request may also include a timestamp identifying when the request was transmitted.

Although the example network environment described above and illustrated in FIG. 15 described with respect to social networking system 120a and game networking system 120b, this disclosure encompasses any suitable network environment using any suitable systems. As an example and not by way of limitation, the network environment may include online media systems, online reviewing systems, online search engines, online advertising systems, or any combination of two or more such systems.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

### Miscellaneous

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A method, comprising:
identifying, by one or more processors, a set of player metrics for players within a game;
determining, by the one or more processors, properties of at least one metric of the set of player metrics for a specified player, the properties identified from one or more user sessions of the specified player;
generating, by the one or more processors, a first gaming instance based on the properties of the at least one metric, the first gaming instance customized to the specified player by generating a customized first gameplay target, a first objective statement defining the first gameplay target, and a first in-game benefit to be awarded to the specified player upon satisfaction of the first gameplay target;
detecting, by the one or more processors, one or more interactions of the specified player with at least one element of the first gaming instance; and
in response to the one or more interactions, generating, by the one or more processors, a second gaming instance based on the properties of the at least one metric, the second gaming instance customized to the specified player and distinct from the first gaming instance and including a customized second gameplay target, a second objective statement defining the second gameplay target, and a second in-game benefit to be awarded to the specified player upon satisfaction of the gameplay target.

2. The method of claim 1, wherein generating the first gaming instance further comprises:
identifying a gaming environment having a set of attributes; and
generating the first gaming instance based on at least one attribute of the set of attributes and the properties of the at least one metric.

3. The method of claim 2 further comprising:
identifying an access permission associated with the gaming environment;
determining the access permission of the gaming environment corresponds with an instance status; and
generating the first gaming instance based on the access permission matching the instance status.

4. The method of claim 1 further comprising:
identifying a number of gaming instances generated for the specified player during a predetermined period of time;
determining the number of gaming instances exceeds an instance threshold for the specified player; and
specifying an incentive modifier for one or more of the first gaming instance and the second gaming instance.

5. The method of claim 1 further comprising:
detecting an intervening gaming instance;
in response to detecting the intervening gaming instance, disabling the second gaming instance;
detecting one or more interactions with the intervening gaming instance, the one or more interactions indicating completion of the intervening gaming instance; and
resuming the second gaming instance in response to completion of the intervening gaming instance.

6. The method of claim 1, wherein the specified player is a first player and the first gaming instance and the second gaming instance are customized to the first player, the method further comprising:
determining properties of at least one metric for a second player of the set of players; and
generating a third gaming instance based on the properties of the at least one metric, the third gaming instance customized to the second player.

7. The method of claim 6, wherein the at least one metric used to generate gaming instances for the first player is a first metric and the at least one metric used to generate gaming instances for the second player is a second metric, the first metric being distinct from the second metric.

8. The method of claim 1, wherein the at least one metric for the specified player is a progress metric for a gaming environment, the method further comprising:
detecting one or more interactions within the gaming environment;
identifying a set of progress thresholds associated with the gaming environment;
determining one or more progress thresholds satisfied by the one or more interactions; and
generating one or more gaming instance based on the one or more interactions and the one or more progress thresholds satisfied by the one or more interactions.

9. A system, comprising:
one or more processors; and
a non-transitory processor-readable storage medium storing processor executable instructions that, when executed by the one or more processors, cause the one or more processors to perform operations comprising:
identifying a set of player metrics for players within a game;
determining properties of at least one metric of the set of player metrics for a specified player, the properties identified from one or more user sessions of the specified player;
generating a first gaming instance based on the properties of the at least one metric, the first gaming instance customized to the specified player by generating a customized first gameplay target, a first objective statement defining the first gameplay target, and a first in-game benefit to be awarded to the specified player upon satisfaction of the first gameplay target;
detecting one or more interactions of the specified player with at least one element of the first gaming instance; and
in response to the one or more interactions, generating a second gaming instance based on the properties of the at least one metric, the second gaming instance customized to the specified player and distinct from the first gaming instance and including a customized second gameplay target, a second objective statement defining the second gameplay target, and a second in-game benefit to be awarded to the specified player upon satisfaction of the gameplay target.

10. The system of claim 9, wherein generating the first gaming instance further comprises:
identifying a gaming environment having a set of attributes; and
generating the first gaming instance based on at least one attribute of the set of attributes and the properties of the at least one metric.

11. The system of claim 10, wherein the operations further comprise:
identifying an access permission associated with the gaming environment;
determining the access permission of the gaming environment corresponds with an instance status; and
generating the first gaming instance based on the access permission matching the instance status.

12. The system of claim 1, wherein the operations further comprise:
identifying a number of gaming instances generated for the specified player during a predetermined period of time;
determining the number of gaming instances exceeds an instance threshold for the specified player; and
specifying an incentive modifier for one or more of the first gaming instance and the second gaming instance.

13. The system of claim 9, wherein the operations further comprise:
detecting an intervening gaming instance;
in response to detecting the intervening gaming instance, disabling the second gaming instance;
detecting one or more interactions with the intervening gaming instance, the one or more interactions indicating completion of the intervening gaming instance; and
resuming the second gaming instance in response to completion of the intervening gaming instance.

14. The system of claim 9, wherein the specified player is a first player and the first gaming instance and the second gaming instance are customized to the first player, the method further comprising:
determining properties of at least one metric for a second player of the set of players; and
generating a third gaming instance based on the properties of the at least one metric, the third gaming instance customized to the second player.

15. The system of claim 9, wherein the at least one metric for the specified player is a progress metric for a gaming environment and the operations further comprise:
detecting one or more interactions within the gaming environment;
identifying a set of progress thresholds associated with the gaming environment;
determining one or more progress thresholds satisfied by the one or more interactions; and
generating one or more gaming instance based on the one or more interactions and the one or more progress thresholds satisfied by the one or more interactions.

16. A non-transitory processor-readable storage medium storing processor executable instructions that, when executed by a processor of a machine, cause the machine to perform operations comprising:
identifying a set of player metrics for players within a game;
determining properties of at least one metric of the set of player metrics for a specified player, the properties identified from one or more user sessions of the specified player;
generating a first gaming instance based on the properties of the at least one metric, the first gaming instance customized to the specified player by generating a customized first gameplay target, a first objective statement defining the first gameplay target, and a first in-game benefit to be awarded to the specified player upon satisfaction of the first gameplay target;
detecting one or more interactions of the specified player with at least one element of the first gaming instance; and
in response to the one or more interactions, generating a second gaming instance based on the properties of the at least one metric, the second gaming instance customized to the specified player and distinct from the first gaming instance and including a customized second gameplay target, a second objective statement defining the second gameplay target, and a second in-game benefit to be awarded to the specified player upon satisfaction of the gameplay target.

17. The non-transitory processor-readable storage medium of claim 16, wherein generating the first gaming instance further comprises:
identifying a gaming environment having a set of attributes; and
generating the first gaming instance based on at least one attribute of the set of attributes and the properties of the at least one metric.

18. The non-transitory processor-readable storage medium of claim 17, wherein the operations further comprise:
identifying an access permission associated with the gaming environment;
determining the access permission of the gaming environment corresponds with an instance status; and
generating the first gaming instance based on the access permission matching the instance status.

19. The non-transitory processor-readable storage medium of claim 16, wherein the operations further comprise:
identifying a number of gaming instances generated for the specified player during a predetermined period of time;
determining the number of gaming instances exceeds an instance threshold for the specified player; and
specifying an incentive modifier for one or more of the first gaming instance and the second gaming instance.

20. The non-transitory processor-readable storage medium of claim 16, wherein the operations further comprise:
detecting an intervening gaming instance;
in response to detecting the intervening gaming instance, disabling the second gaming instance;
detecting one or more interactions with the intervening gaming instance, the one or more interactions indicating completion of the intervening gaming instance; and
resuming the second gaming instance in response to completion of the intervening gaming instance.
